(19) United States
(12) Patent Application Publication
(10) Pub. No.: US 2002/0045437 A1
(43) Pub. Date: Apr. 18, 2002

(54) Tracing a location of a mobile device

(76) Inventor: Alexander Kesler, Chestnut Hill, MA (US)

Correspondence Address: DAVID L. FEIGENBAUM, Fish & Richardson P.C., 225 Franklin Street, Boston, MA, 02110-2804, US

(21) Appl. No.: 09/931,584

(22) Filed: Aug. 16, 2001

Related U.S. Application Data
(60) Provisional application No. 60/226,231, filed on Aug. 18, 2000.

(51) Int. Cl. H04M 1/66

(52) U.S. Cl. 455/411; 455/414; 455/415

(57) ABSTRACT

A server on the Internet detects that a mobile device communicating with the server may have been stolen, and a telephone call is made to a call center to initiate action in response to the alert.

### BACKGROUND

The application claims the benefit of the filing date of U.S. provisional patent application Ser. No. 60/226,231, filed Aug. 18, 2000, and incorporated by reference.

This invention relates to tracing a location of a mobile device.

Laptops and other mobile devices are especially susceptible to theft. Thefts cause the loss not only of the computer but also of information stored on hard drives. Tracing the location of a laptop computer, for example, can help in recovering it when it is stolen.

One proposed way to trace the location of a computer is to install tracing software on a hard drive in the computer. The tracing software calls an (800) phone number of a call monitoring center periodically (daily, multiple times a day, weekly, or multiple times a week). When each call is answered, the computer logs onto a network, identifies itself, disconnects, and stays idle until the next call. The call center must answer multiple toll-bearing calls periodically for each of the devices that participate in the service. As demand for the service grows, additional servers must be added to the call center.

### SUMMARY

In general, in one aspect of the invention, a server on a publicly accessible communication network detects that a mobile device communicating with the server is marked in server's database as “stolen”, an alert signal is generated towards this communicating client device and a telephone call is made to a call center to initiate action in response to the alert.

Implementations of the invention may include one or more of the following features. The publicly accessible communication network includes the Internet. The detecting includes analyzing a message sent from the mobile device to the server, the message containing information identifying the mobile device. The message is sent from the mobile device to the server without indicating the sending of the message to a user of the mobile device. A periodic series of messages is sent from the mobile device to the server, at least one of the messages containing information identifying the mobile device. The message includes a time, an address of the mobile device, a registration number, and an identification value of the mobile device. The mobile device is a computer. The mobile device disconnects from the network in response to the detecting that the mobile device has been marked as stolen in a server database, and a graphical user interface on the mobile device continues to appear as if the device is connected to the network. A caller ID associated with the telephone call is recorded.

In general, in another aspect, the invention features software that is configured to enable a device to receive a message from a server indicating a possibility that the device has been stolen, and in response to the message, initiating a telephone call to a service location.

In implementations of the invention, the software is also configured to cause the device to send a message to the server through a network, the message identifying the device to the server.

Among the advantages of the invention are one or more of the following: The software is difficult to detect on the computer being traced. The tracing software uses relatively little space on the hard drive and does not hamper the operation of other programs. Main and auxiliary client software modules are not visible on the hard drive. The working program also is not visible in WinNT/2000/98/ME “Task Manager”. Main threads of the program are specially secured in WinNT, which makes it complicated to stop working threads even by purposeful actions. The tracing software effectively traces the computer's unique ID number through the Internet. Because the tracing software disconnects from the Internet and calls an (800) phone number without any prompt or alert, the user (a thief or person in possession of a stolen computer) is unaware of and unable to stop the process. Information necessary to locate and retrieve the stolen property is obtained. The tracing software is easily installed over the Internet. but the system is secure, however, because it a uses strong encryption algorithm for encoding of transferred data and digital signatures for reliable authorization of the data source. The software is simpler, as effective, and cheaper to operate than other techniques because the computer does not repeatedly call an (800) number at times when the computer has not been identified as stolen. Connections are made over the Internet and fewer calls are made from all of the subscribers. The tracing software is more efficient because it uses an alternative free network (the Internet) to monitor the computer until it is stolen. Only then, after the computer is determined to have been stolen does the software uses an (800) number and a call center to get the Caller ID info.

Other advantages and features will become apparent from the following description and from the claims.

### DESCRIPTION

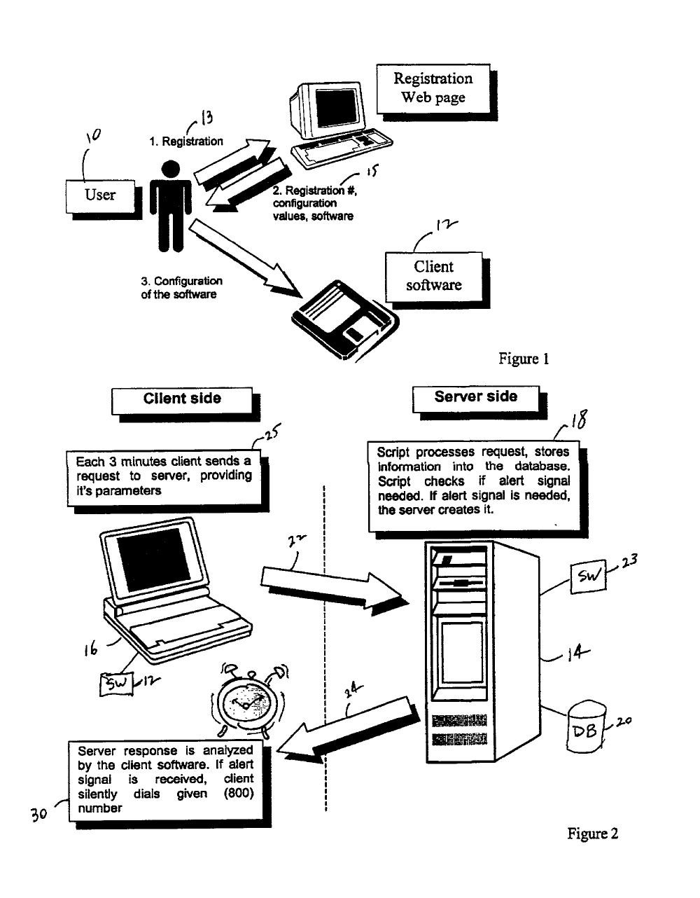

(FIGS. 1 and 2 show schematic flow diagrams.

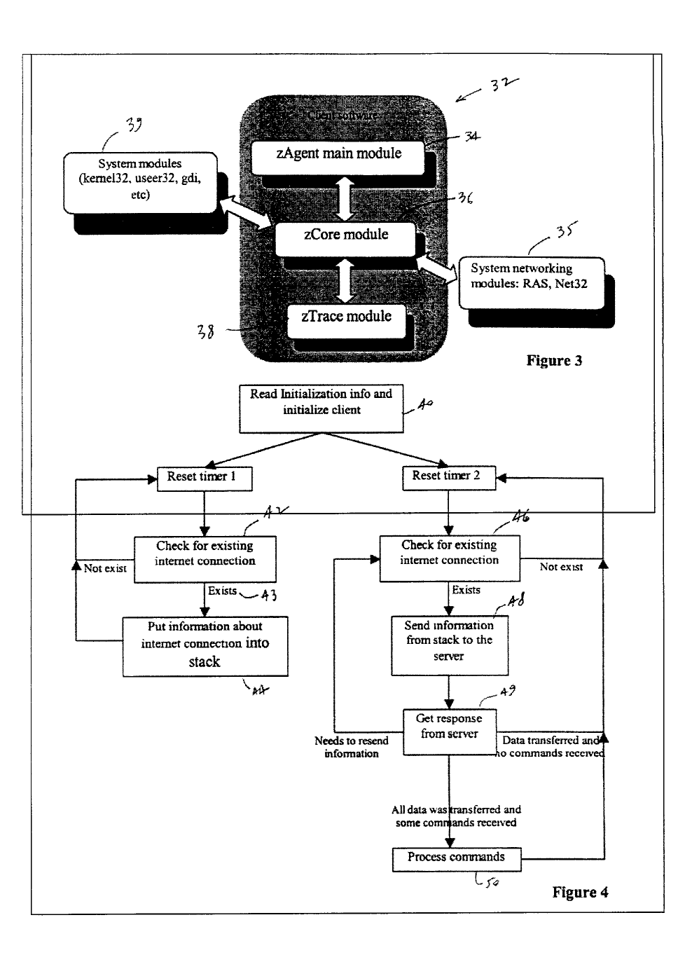

FIG. 3 shows a block diagram of client software.

FIG. 4 shows a flow chart.

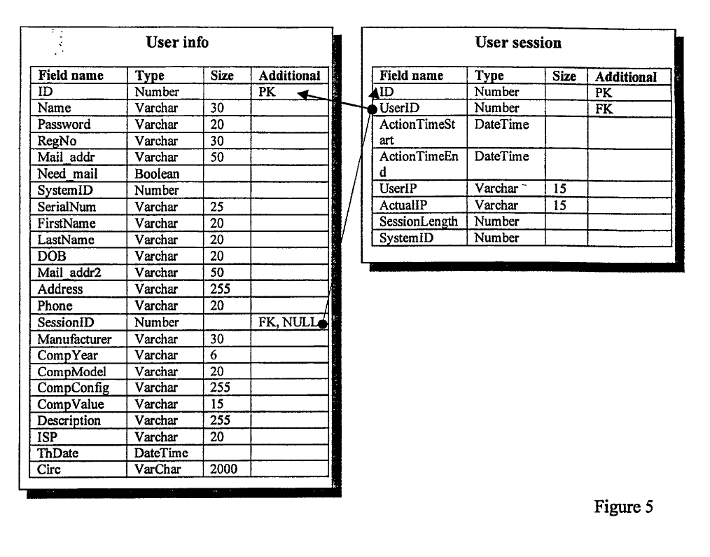

FIG. 5 shows database tables.)

As shown in FIGS. 1 and 2, a user 10 installs client tracing software 12 on the computer 16 that is to be traced. The presence of the tracing software on the computer is invisible to any user of the computer because it provides no visible user interface, buttons, icons, directories, or sounds. Each time the user connects the computer to the Internet, the tracing software connects to a tracing server 14 through the Internet. As part of the connection, the tracing software reveals the user's location to the tracing server.

If the computer is stolen, the owner notifies the tracing service by email, fax, web, or phone. The tracing server is then set to be “on the lookout” for a connection from the stolen computer. When the stolen computer later connects to the server, its location is traced in a manner described below, and an automatic notification is sent to the registered owner by e-mail. After the location is traced, a police report is generated and a recovery officer employed by the tracing service works to ensure timely recovery of the stolen property to the owner.

After downloading from the server, the client will reside in the computer's hard drive. Part of the software (the download trigger) will be installed onto track zero. Thus, if the hard drive is formatted, the software will download invisibly and install itself, which significantly reduces the opportunity for tampering. Because each computer's customer ID number is stored in a tracing server's database 20, every time the owner connects to the Internet, the tracing software will be able to track the computer. If the computer gets stolen, and the owner notifies the tracing server, the next time the computer is connected to the Internet, the tracing server will obtain the IP address of the session. After the IP address is traced, the tracing server will communicate with the stolen computer, notifying it that it was stolen. This alert to the stolen computer activates a feature of the client tracing software that triggers the following sequence:

The computer disconnects from the Internet, even though it will appear to the unauthorized user to be still connected. The computer silently dials a preprogrammed call center (800) number where the unauthorized user's caller ID (ANI) is recorded. The call center is configured to recognize all blocked and private numbers. Then, the PC will return to its normal operation.

The IP address is traced in the following way: There are two IP addresses in a network context. One is the IP address of the mobile device within the internal network, the other is the IP address of the whole network (e.g., if the client is located behind a firewall or a proxy server). In case of a dial-up connection to a network both IP addresses are the same. The client tracing software uses standard Windows wininet.dll.

When the client tracing software is trying to connect to the tracing server, the client tracing software needs to know its own IP address as well as the tracing server address.

When the Internet connection is initiated, the local address is automatically entered by the operating system (in accordance with previously installed settings). Thus, the local address can be read by GetHostByName Windows Sockets function.

When the HTTP server is being contacted by a tracing client, the server is automatically sent certain info about the source of the contact such as, host address, traced IP root from client to server (a chain of IP addresses of all interim servers between client's computer and system's server), security settings, type of request, type of data. The server processes that information and automatically assigns variables to each value. The variable that is needed is found under ServerVariables and is called “UserIP”

The tracing software includes a client part and a server part. The server part runs on the tracing server and is always in the “receiving mode” for incoming communications from computers on the network that have the client tracing software installed.

As shown in FIGS. 1 and 2, the client part 12 is installed by the user on his computer 16. After registering 13, the user is automatically assigned a registration number 15 that uniquely identifies the client in a database 20 associated with the tracing server 14.

The client part of the tracing software autoloads when the client computer is started. When the client part of the tracing software is loaded, it determines whether the Internet is available and then sends a report to the tracing server through the Internet, establishing a session. Thereafter, whenever the client software determines that the computer is connected to the Internet, the client tracing software sends 22 another report to the tracing server and receives responses 24.

Each client report includes a current local time value (determined from the system clock), the client's IP address, the client's assigned registration number, and the system ID of the computer. The system ID is determined by the client tracing software and is unique by default.

The server tracing software continually waits for a client connection. When a connection occurs, the server tracing software receives the reported information and stores it into the server database 20. The server tracing software 23 analyzes the client information to make sure that the received system ID matches the locally stored system ID and makes a decision whether or not to respond with an alert.

The client tracing software operates under Windows 95/98/2000 and Windows NT 4.0 Server/Workstation. No additional software or libraries are needed. The hard disk requirements are 1.6 Mb. The server tracing software runs under Windows 2000, Windows NT 4.0 Server. Additional software and libraries that are required include Internet Information Server 3.0 with ASP extensions or higher, Microsoft SQL Server 6.5 or higher or active ODBC connection and ADO objects.

As shown in FIG. 2, the client tracing software is eventdriven. Almost 95% of time the client tracing software 12 is in an idle state.

As indicated in FIG. 4, after reading initialization information and initializing the client 40, the client software manages two independent timers: reset timer 1, an “Internet timer”, and timer 2, a system timer. (A user has an ability to separately change the time intervals for both timers.)

Every N1 (for example, 5) minutes (according to the Internet timer 1) the client tracing software checks the availability of the Internet 42 and if available 43 creates a record containing the time when the check was made. This record is then stored in a data stack 44.

Every N2 (for example, 20) minutes (according to the system timer 2) the client tracing software checks for an Internet connection 46, and checks the availability of the server 48 and (if available) sends all data available at that moment in the data stack to the server. Then the client tracing software waits for a response from server. When a response is received from the server 49, if all data was successfully transferred and commands have been received, the client processes the commands 50.

The server receives 18 the client's report, parses the information packet sent from the client, stores all data concerning the Internet availability in the database in the server and analyzes any other information received from client tracing software. As a result, the system's database at the server contains a list of times when the Internet was available. This provides a basis for reliably calculating the “Internet” session lengths and reduces the need to synchronize the local and server timelines. The client interacts with the server using XML formatted commands. The basic commands are “Alert notification” (sent to client) and “Update notification”. The first one forces the client software to dial a call center. One of the parameters of this command is the phone number to dial. In that way, the client tracing software is able to make phone calls in a more flexible manner (for example, for different areas could be different call centers). Also, there are several other parameters that notify client software about the calling scheme: disconnect from the Internet and make a call in a predefined time period (30 minutes, 2 hours, etc), make a call at 3 AM, etc.

The “Update notification” command forces the client tracing software to analyze what is the number of installed version and compare it to the number of the version available for the latest update. If the newer version is available, the client software downloads the update through one of available channels (http, smtp). The server also compares the reported System ID with the original stored value. If they do not match and the user has an “activate tracing” option set, the server will trigger an alarm signal causing the mobile device to initiate a call to the call center 30, as explained elsewhere.

The client packet consists of information on Internet sessions plus information identifying the particular computer (complete hardware profile) and some registration information (registration number). As shown in FIG. 3, the client tracing software 32 includes three main modules: zAgent 34, zCore 36, and zTrace 38. This architecture allows the zTrace software to use system resources effectively and to be easily extended in the future.

The zAgent realizes basic client functionality. It provides reliable autoloading of the client software immediately after the computer boots. The zAgent module is also is able to change the names and locations of client software modules on the client computer, making them undetectable.

The zCore module implements all communication functionality. Both client and server software use transactions for transferring data, which guarantees integrity of the information received by each side. zTrace controls phone calling process, gathering of the identifying information and tracing of the computer's location.

For all client software modules, a server-centralized error gathering system provides for receipt of the error statistics on the server side. zCore and zTrace contain a collection of functions to communicate to RAS, NetBIOS system functions 35 and to determine availability of the Internet. These functions include function RASLibInit, function RASLibClose, function DetermineNetDevice, function IsModemConnected, function CloseDefaultConnection, function DialNumber, function RASCloseConnection, function IsModemHere, function DetermineNetDevice2, function DetermineNetDevice3, function GetMACAddress, function CloseAliConnections, function InetIsOnLine, function WinInetModem, function GetSystemID.

The library also 36 contains a function GetSystemID, which determines the computer's unique serial number (a serial number of the hard drive). The tracing software uses the following system libraries 39: ADVAPI32.DLL, COMCTL32.DLL, DNSAPI.DLL, GD132.DLL, KERNEL32.DLL, LZ32.DLL, MSVCRT.DLL, NETAPI32.DLL, NETRAP.DLL, NTDLL.DLL, OLE32.DLL, OLEAUT32.DLL, RASLIB.DLL, RPCRT4.DLL, SAMLIB.DLL, SECUR32.DLL, SHELL32.DLL, SHLWAPI.DLL, USER32.DLL, VERSION.DLL, WININET.DLL, WLDAP32.DLL, WS2HELP.DLL, WS2_{—}32.DLL, WSOCK32.DLL.

FIG. 5 shows a data structure for use in the server.

Referring to FIG. 5, the user information that is maintained by the server is shown in table 56. When a session between a client and the server is active, a user session table 58 maintains information about the session.

Other embodiments are within the scope of the following claims.

For example, the tracing software can be used with any kind of IP-capable mobile device, including laptops, desktop computers, personal digital assistants (PDAs) personal information managers (PIMs), web enabled TVs, IP compatible cellular phones, and other IP compatible equipment.

1. A method comprising
detecting at a server on a publicly accessible communication network that a mobile device communicating with the server may have been stolen, and
making a telephone call to a call center to initiate action in response to detecting that the mobile device may have been stolen.

2. The method of claim 1 in which the publicly accessible communication network comprises the Internet.

3. The method of claim 1 in which the detecting comprises analyzing a message sent from the mobile device to the server, the message containing information identifying the mobile device.

4. The method of claim 3 in which the message is sent from the mobile device to the server without indicating the sending of the message to a user of the mobile device.

5. The method of claim 3 in which a periodic series of messages is sent from the mobile device to the server, at least one of the messages containing information identifying the mobile device.

6. The method of claim 3 in which the message includes a time, an address of the mobile device, a registration number, and an identification value of the mobile device.

7. The method of claim 1 in which the mobile device comprises a computer.

8. The method of claim 1 also including
causing the mobile device to disconnect from the network in response to detecting that the mobile device may have been stolen, and
causing a graphical user interface on the mobile device to continue to appear as if the device is connected to the network.

9. The method of claim 1 also including
recording a caller ID associated with the telephone call.

10. Apparatus comprising a media on which is stored software capable of configuring a device to
receive a message from a server indicating a possibility that the device has been stolen, and
in response to the message, initiating a telephone call to a service location.

11. The apparatus of claim 10 in which the software is also configured to cause the device to send a message to the server through a network, the message identifying the device to the server.
